(19) United States
(12) Patent Application Publication
(10) Pub. No.: US 2020/0295628 A1
(43) Pub. Date: Sep. 17, 2020

(54) Electric Machine Having A Cooling Device

(71) Applicant: ZF Friedrichshafen AG, Friedrichshafen (DE)

(72) Inventors: Heinz REICHERT, Markdorf (DE); Kai BORNTRAGER, Langenargen (DE); Axel Michael MÜLLER, Friedrichshafen (DE); Michael TRÜBENBACH, Friedrichshafen (DE)

(21) Appl. No.: 16/086,062

(22) PCT Filed: Feb. 21, 2017
(86) PCT No.: PCT/EP2017/053935

§ 371 Date: Sep. 18, 2018

(30) Foreign Application Priority Data
Mar. 24, 2016 (DE) 10 2016 204 980.1

(51) Int. Cl. H02K 9/197; H02K 5/173; H02K 5/20

(52) U.S. Cl. CPC H02K 9/197; H02K 5/20; H02K 5/1735

(57) ABSTRACT

An electric machine 10 includes a stator with a stator winding with winding heads protruding axially over the stator lamination stack. A winding head is potted with a thermally conductive potting compound which forms an outer circumferential surface and an inner circumferential surface. The outer circumferential surface is in thermally conducting contact with a stator support, and the stator has a cylindrical interior space in which a rotor which is rotatably mounted by a rotor shaft is arranged accompanied by formation of a radial air gap. The electric machine has a first fluid cooling device for wetting the inner circumferential surface of a winding head with a cooling fluid. At least one first fluid conducting element is formed so that a cooling fluid introduced into the interior space is substantially prevented from penetrating into the air gap between rotor and stator.

### PRIORITY CLAIM

This is a U.S. national stage of application No. PCT/EP2017/050192, filed on Jan. 5, 2017. Priority is claimed on the following application: Country: Germany, Application No.: 10 2016 201 870.1, filed: Feb. 8, 2016; the content of which is/are incorporated herein in its entirety by reference

The present invention is directed to an electric machine having a cooling device.

### FIELD OF THE INVENTION

An electric machine of the type mentioned above is already known from US2002/0135245, wherein winding heads of a stator winding which protrude axially over a stator lamination stack are overmolded with a thermally conductive plastic and are in heat exchange contact with a cooling jacket of a fluid cooling device via the potting. In this way, the heat losses occurring in the winding head can be dissipated together with the heat losses occurring in the stator lamination stack via a common cooling system, and the power of the electric machine can be increased.

However, a problem consists in that when heat is dissipated radially from the winding heads to a cooling device arranged radially outwardly of the latter a transfer of heat must take place through a radial potting medium layer which, due to geometrical factors, is relatively heavy and has a comparatively poor thermal conductivity, which can lead to an unwanted buildup of heat when the electric machine is in operation and to a rise in operating temperature and reduced efficiency.

### SUMMARY OF THE INVENTION

In view of the foregoing, it is an object of the present invention to enable a further increase in power of the electric machine in a given constructional size. The invention aims to further increase the power density of an electric machine by undertaking measures to improve dissipation of power losses.

According to the present invention, it is provided that the winding heads which are potted with a thermally conductive plastic are cooled via the outer circumferential surface and additionally also via the inner circumferential surface of the winding heads so that extraction of heat losses can be quantitatively increased.

For purposes of heat extraction in the case of an electric inrunner machine, the outer circumferential surface of a winding head is in thermally conductive contact with an outer stator support in a known manner, while the inner circumferential surface of a winding head can be wetted with a cooling fluid via a first fluid cooling device, accordingly allowing heat to be extracted directly from the interior of the electric machine. This cooling via the inner circumferential surfaces of the winding heads is particularly effective in an inrunner motor because a radial dimension of the potting compound extending from the surface to be cooled to the winding is comparatively small. Therefore, the risk of heat buildup is negligible compared to an outer circumferential surface of the winding heads. Heat is likewise extracted from the axial front sides of the winding heads through the action of the first fluid cooling device.

The inventive electric machine is further provided with a first fluid conducting element which is secured to the winding head and formed in such a way that a cooling fluid introduced into the interior during operation of the electric machine is substantially impeded from penetrating into the air gap located between the rotor and the stator. This means that although there is free fluid present in the interior in the area of the winding heads, this fluid does not penetrate into the air gap of the electric machine and generate unwanted drag losses and power losses. At the same time, a cooling fluid in the form of oil is also protected against unwanted thermal loading occurring in the air gap which would result in a destruction of the chemical chain structure of the oil and, therefore, in an unwanted premature degradation of the oil.

Thus based on the present invention, a noticeable increase in power of the electric machine can be achieved. The first fluid cooling device can accordingly also be constructed in particular as an oil cooling device, and this can be utilized at the same time to lubricate the bearings of the rotor shaft as will be discussed at greater length later.

According to an advantageous configuration, the fluid conducting element can be disk-shaped or pot-shaped in particular and can have a dividing wall area which is secured to an inner circumferential surface of a winding head so as to be substantially tight against fluid by a radially outer fastening portion, possibly including a sealing element, this dividing wall area being constructed so as to be closed with the exception of a central through-opening for the rotor shaft. In this way, the interior of the electric machine is again divided into a substantially dry rotor space and into wet spaces axially adjacent thereto for the winding head located at the front side of the stator.

The first fluid conducting element can advantageously have an axial stop cooperating with a winding head. An axial stop of this kind secures the axial position of a fluid conducting element in the direction of the rotor and prevents the fluid conducting element from being pulled into the area of the rotor and destroyed. As has already been mentioned, the first fluid conducting element can be constructed on the whole in a substantially pot-shaped manner so that the dividing wall area forms a pot base and the axial stop is formed at a cylindrical portion connected to the base. The axial stop can be formed in particular as a one-sided radial collar which contacts a potted body formed of a potting compound and the winding head. Further, the cylindrical wall area can be arranged or can extend at a radial distance from the winding heads and can have in circumferential direction a plurality of recesses, particularly recesses having the largest possible surface area, for passage of a cooling fluid. The first fluid conducting element can be secured in position additionally, for example, through a catch connection and by an adhesive.

According to a further embodiment, the first fluid conducting element can also extend at the front side axially beyond a winding head and can be axially supported by an axial supporting surface at a housing element, e.g., a bearing endshield. Supporting surfaces acting axially at both sides are advantageously provided at a fluid conducting element of this kind such that the fluid conducting element can be axially embedded or clamped in when installed and can accordingly be captively secured to, or relative to, the stator. In this case, further retaining means can be omitted.

Further advantageously, the first fluid conducting element can have in the area of the central through-opening for the rotor shaft a fluid repelling surface which opens toward a front side of the electric machine and through which a fluid impinging on it is repelled in direction of the front side. In particular, the fluid repelling surface can be conical or spherical so that a fluid flow directed toward the rotor is reflected back into the axial region of the winding heads.

To prevent whirling and a development of heat induced by it, it is further suggested to produce the first fluid conducting element from a non-ferromagnetic material. This fluid conducting element can preferably be made of a heat-resistant plastic, particularly from a thermoplastic or thermosetting plastic material.

According to a preferred embodiment of the invention, the cooling fluid can be supplied via the rotor shaft, for which purpose a fluid inlet channel is formed in this rotor shaft and is fluidically connected with an area of the interior, i.e., a wet space, mentioned above, facing a front side of the stator by at least one first fluid outlet opening. In an advantageous manner, a plurality of fluid outlet openings are provided so as to be distributed around the circumference of the rotor shaft and also at both areas of the winding heads located at the front side of the stator.

An improved separation of the rotor space from fluid is achieved in that a second fluid conducting element which, together with the first fluid conducting element, forms a labyrinth seal for the cooling fluid is formed in the area of the first fluid outlet opening. Recesses or contours are further provided in this axial area at the rotor shaft which cause the fluid to be slung back into the wet space from the rotor space while the machine is running, for which purpose the above-mentioned structures lie opposite one another radial to the fluid repelling surface of the first fluid conducting element.

As has already been mentioned, the first fluid cooling device can be utilized for cooling the winding heads and simultaneously lubricating the rotor bearings in that the rotor shaft has in the area of the second fluid conducting element at least one second fluid outlet opening which is arranged axially adjacent to a rotor bearing. In order to achieve a fluid flow directed to a rotor bearing, the second fluid conducting element can extend in direction of the rotor bearing and axially overlap the second fluid outlet opening at a radial distance therefrom. In this way, a fluid flow exiting from the second fluid outlet opening is supplied directly to an adjacent rotor bearing through the second fluid conducting element.

In a particularly advantageous manner, the first fluid cooling device is formed as an oil circuit which is completed by a coolant pump and a heat exchanger. While lubricant or coolant is supplied via the rotor shaft, a fluid outlet channel is formed for discharging the coolant, this fluid outlet channel being formed at the bottom geodesically relative to the stator with respect to a normal operating position of the electric machine. This fluid outlet channel is fluidically connected to the interior of the electric machine at least by one fluid inlet opening.

As has already been stated, some of the heat losses occurring in the winding heads are guided off to the stator support via the outer circumferential surface of the winding heads. In this respect, it may be advantageous in order to further improve heat dissipation if the electric machine has a second fluid cooling device with a fluid cooling jacket formed at the stator. This second fluid cooling device can be constructed as a water cooling device or as an oil cooling device, and the fluid cooling jacket has a first wall element and a second wall element which are formed so as to be substantially cylindrical, spaced apart from one another radially and sealed relative to one another.

The first wall element can advantageously comprise the stator support, and the second wall element can advantageously be formed as a housing of the electric machine. The second fluid cooling device accordingly serves to remove heat losses imposed via the stator lamination stack and, at the same time, the heat losses occurring in the winding heads. To this end, the fluid cooling jacket can advantageously extend axially entirely or at least partially along the winding heads at the stator which are potted with potting compound.

### BRIEF DESCRIPTION OF THE DRAWINGS

The invention will be described in the following by way of example with reference to the accompanying figures, in which:

FIG. 1 is a schematic view of an electric machine in longitudinal section;

FIGS. 2A, B is an enlarged sectional view of the electric machine from FIG. 1 in the region of the winding heads of the stator with first fluid conducting elements arranged therein;

FIGS. 3A, B is a further view of an electric machine in the region of the winding heads of a stator with first fluid conducting elements arranged therein in an alternative embodiment form.

### DETAILED DESCRIPTION OF THE PRESENTLY PREFERRED EMBODIMENTS

Like subject matter, functional units or comparable components are designated by like reference characters throughout the figures. Further, summarizing reference characters are used for components and objects which occur several times in an embodiment example or in a diagram but which are collectively described with respect to one or several features. Components or objects which are designated by like or summarizing reference characters may be implemented alike but also differently with respect to individual, several or all features such as, e.g., the dimensioning, insofar as the description does not implicitly or explicitly indicate otherwise. Identical subject matter, functional units and comparable components in various embodiment examples are not described repeatedly so as to avoid repetition, and only the differences between the embodiment examples are described.

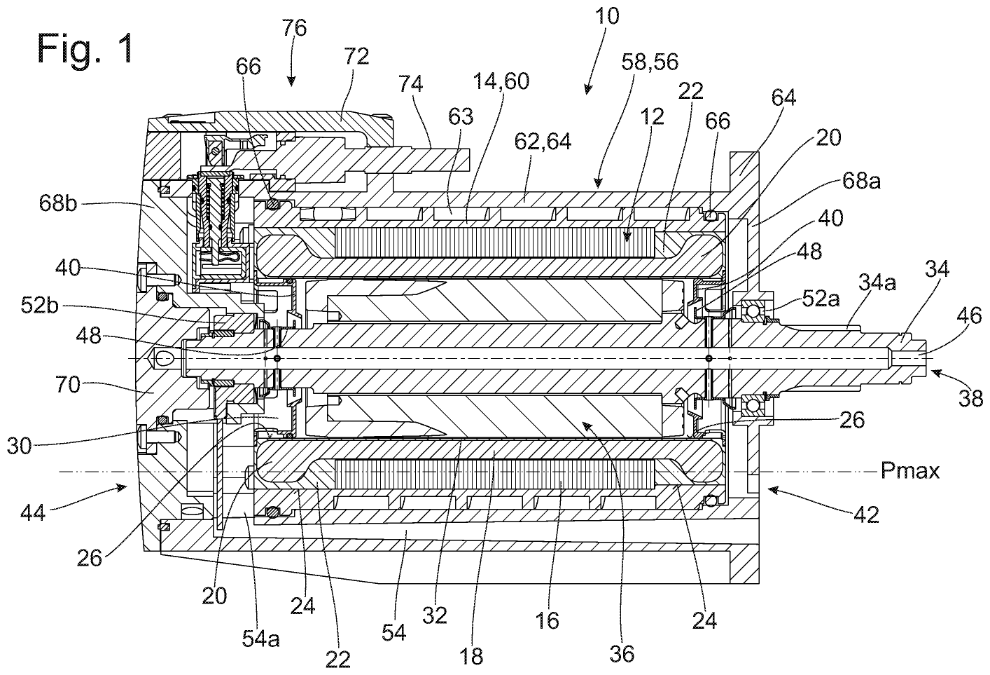

FIG. 1 shows an electric machine 10 which is formed as an asynchronous motor and provided in a powertrain of a motor vehicle for transmitting a drive torque to vehicle wheels. To this end, the electric machine 10 comprises a stator 12 arranged in a housing 64 and a rotor 36 which is rotatably mounted therein and arranged on a rotor shaft 34 via which power can be tapped for driving the vehicle.

The stator 12 comprises a cylindrical stator support 14 with a stator lamination stack 16 secured to the latter. This stator lamination stack 16 is constructed in a known manner with a yoke and with stator teeth which are directed radially inward and which carry a stator winding 18 with winding heads 20 protruding axially over the stator lamination stack 16. The stator winding 18 is connected to a plurality of external connection lines 74 by a power connection unit 76 inside a switchbox 72 arranged at the housing 64, and electrical power can be impressed into the stator winding 18 by an energy storage, not shown, through the external connection lines 74.

As can be seen in FIGS. 1; 2A, B, the stator winding 18 extends axially on both sides beyond the stator lamination stack 16 and forms winding heads 20 in these areas. These winding heads 20 are potted with a thermally conductive potting compound 22, particularly a thermally conductive plastic, so that an outer circumferential surface 24 and an inner circumferential surface 26 are formed axially on both sides at the stator 12. The outer circumferential surface 24 is in thermally conducting contact with the stator support 14 which is formed as a first wall element 60 of a fluid cooling jacket 58. The fluid cooling jacket 58 further comprises a second wall element 62, constructed in this instance as the housing 64 of the electric machine 10, which is likewise formed substantially cylindrically, is spaced apart radially from the first wall element 60 and sealed relative to the latter by sealing elements 66. A helical fluid cooling channel 63 in which a coolant circulating, for example, as oil or water is guided between the electric machine 10 and a heat exchanger, not shown, extends between the wall elements 60, 62. Accordingly, as a whole, the above-described arrangement provides a fluid cooling device 56.

In a known manner, the rotor 36 is formed as a squirrel cage rotor and is rotatably mounted by the rotor shaft 34 in a cylindrical interior space 30 formed by the stator 12 accompanied by formation of a radial air gap 32. The rotor shaft 34 is supported by two rotor bearings 52a, b which are constructed as rolling element bearings and which are secured on the one hand in a bearing endshield 68a formed as a housing base and, on the other hand, in a bearing endshield 68b. A portion of the rotor shaft 34 exiting axially from the housing base or bearing endshield 68a can be connected to further components of a vehicle powertrain via a toothing 34a provided on it. The bearing endshield 68b is closed on the axially opposite side by a housing cover 70.

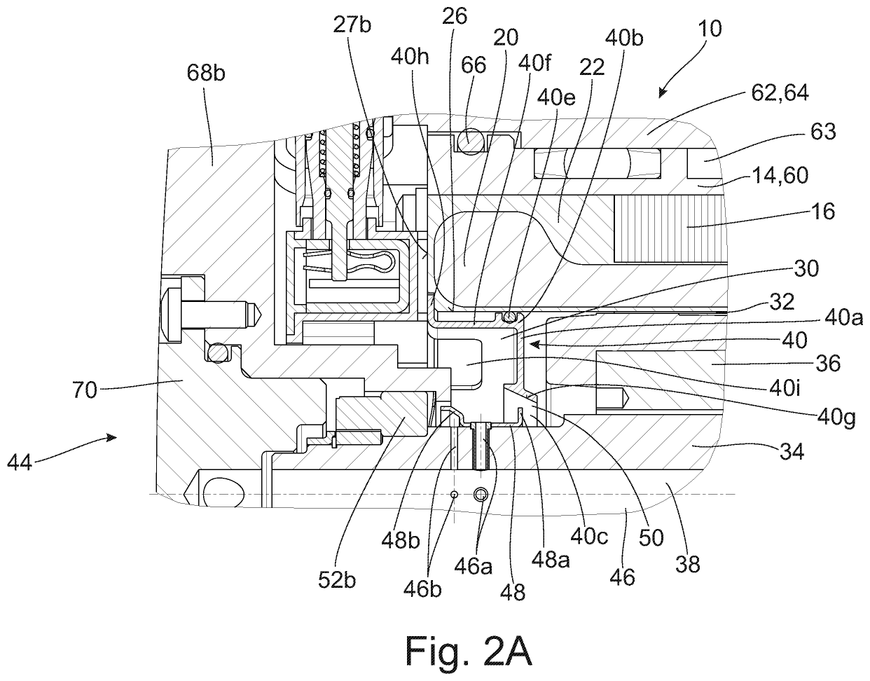

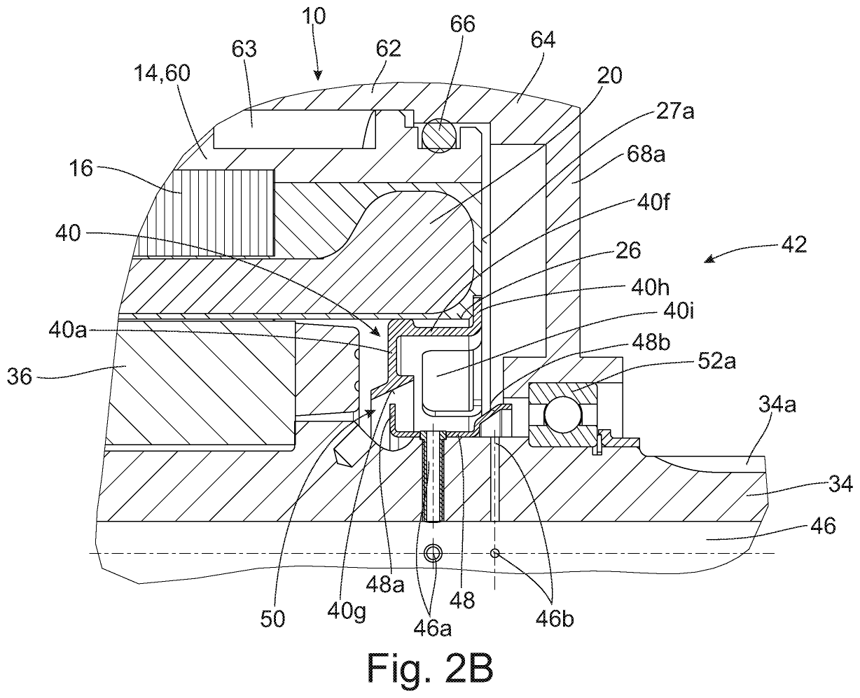

In addition to fluid cooling device 56, the electric machine 10 has a further fluid cooling device 38, in particular with an oil as cooling fluid, with which the inner circumferential surfaces 26 of the winding heads 20 and at least partially also the end faces 27a, b thereof can be wetted. For this purpose, a fluid inlet channel 46 having a plurality of first fluid outlet openings 46a (FIGS. 2a, b) at both axial positions of the winding heads 20 is formed inside the rotor shaft 34. Accordingly, these fluid outlet openings 46a are fluidically connected with those areas of the interior space 30 which face the front sides 42, 44 of the electric machine 10. In order to prevent fluid from entering the axial area of the rotor 36, first fluid conducting elements 40 are provided in the present instance at both winding head positions and are secured, respectively, to a potted winding head 20 and formed in such a way that a fluid introduced into the interior space 30 is substantially prevented from penetrating into the air gap 32 between rotor 36 and stator 12 during operation of the electric machine 10.

In particular, a first fluid conducting element 40 of this type has a substantially closed dividing wall area 40a which is secured in a substantially fluid-tight manner to the inner circumferential surface 26 of a winding head 20 by a radially outer fastening portion 40b accompanied by a sealing element 40e. This dividing wall area 40a is constructed so as to be closed with the exception of a central through-opening 40c for the rotor shaft 34.

As can be seen in FIGS. 1; 2A, B, the fluid conducting element 40 is constructed in a substantially pot-shaped manner, and the dividing wall area 40a forms a base. A cylindrical portion 40f extends from this dividing wall area 40a in direction of the front side 44 and contacts the potting compound of the winding head 20 at the front side by an annular collar 40h which protrudes radially outward. The cylindrical portion 40f is guided at a radial distance to the inner circumferential surface 26 of a winding head 20 and has a plurality of large-area recesses 40i which are distributed along the circumference and by which the cooling fluid can pass through to the winding heads 20. Radially inwardly in the area of the through-opening 40c, a first fluid conducting element 40 forms a fluid repelling surface 40g which opens toward a front side 42, 44 of the electric machine 10 and through which a fluid impinging on it is repelled in direction of the front side 42, 44 and is kept away from the rotor space. It can further be seen that the rotor shaft 34 has in the area of the first fluid outlet opening 46a a second fluid conducting element 48 which, together with the first fluid conducting element 40, forms a labyrinth seal 50 for the cooling fluid. A second fluid conducting element 48 is constructed as a sleeve which is fitted on the rotor shaft 34 and forms radially opposite the first fluid conducting element 40 in the area of the fluid repelling surface 40g an annular collar 48a which protrudes radially outward so that a labyrinth seal 50 is formed from elements 40g and 48a and substantially prevents cooling fluid from entering the area of the rotor 36 during rotation of the rotor 36. The first fluid conducting element 40 is produced in the present instance from a non-ferromagnetic material, particularly from a heat-resistant plastic, while the second fluid conducting element 48 can be a plastic element or a metal element, for example, a sheet-metal sleeve.

Second fluid openings 46b are provided at the rotor shaft 34 in the area of the second fluid conducting element 48 for lubrication of the rotor bearings 52a, b. These fluid outlet openings 46b are arranged axially adjacent to the rotor bearings 52a, b and are overlapped by a conducting portion 48b of the second fluid conducting element 48. In other words, the second fluid conducting element 48 extends in direction of a rotor bearing 52a, b so as to overlap the second fluid outlet openings 46b at a radial distance therefrom. Accordingly, a fluid flow exiting from the second fluid outlet openings 46b can be selectively directed to the rotor bearings 52a, b through the second fluid conducting elements 48.

To guide off the fluid located in the interior space 30, the fluid cooling device 38 has a fluid outlet channel 54 (FIG. 1) which is formed at the bottom geodesically with respect to the stator 12 in a normal operating position of the electric machine 10 and which is fluidically connected to the interior space 30 by a fluid inlet opening 54a. A maximum level Pmax. for the cooling fluid is indicated in FIG. 1 and is set radially between air gap 32 and fluid inlet opening 54 in this operating position. Referring again to fluid cooling device 56, it is further shown that the fluid cooling jacket 58 at stator 12 extends in axial direction almost completely over the winding heads 20 which are potted with potting compound 22.

For production of the electric machine, the stator 12 with the stator lamination stack 16 and stator winding 18 can be produced first. Winding heads 20 protrude axially at both sides over the stator lamination stack 16. In a further step, this pre-built unit is inserted into the cylindrical stator support 14, whereupon the winding heads 20 can be potted with a potting compound 22. The unit produced in this way can then be inserted into the housing 64, a first fluid conducting element 40 being secured to the winding heads already on the bearing endshield 68a formed by the housing base. The rotor 36 can now be inserted with the second fluid conducting elements 48, and the rotor shaft 34 is guided through the rotor bearing 52a on the aforementioned side 42 of bearing endshield 68a. Subsequently, the first fluid conducting element 40 is likewise secured to the winding head 20 on the free axial or front side 44. After arranging the power connection unit 76, this front side can also be closed through the bearing endshield 68b and the housing cover 70.

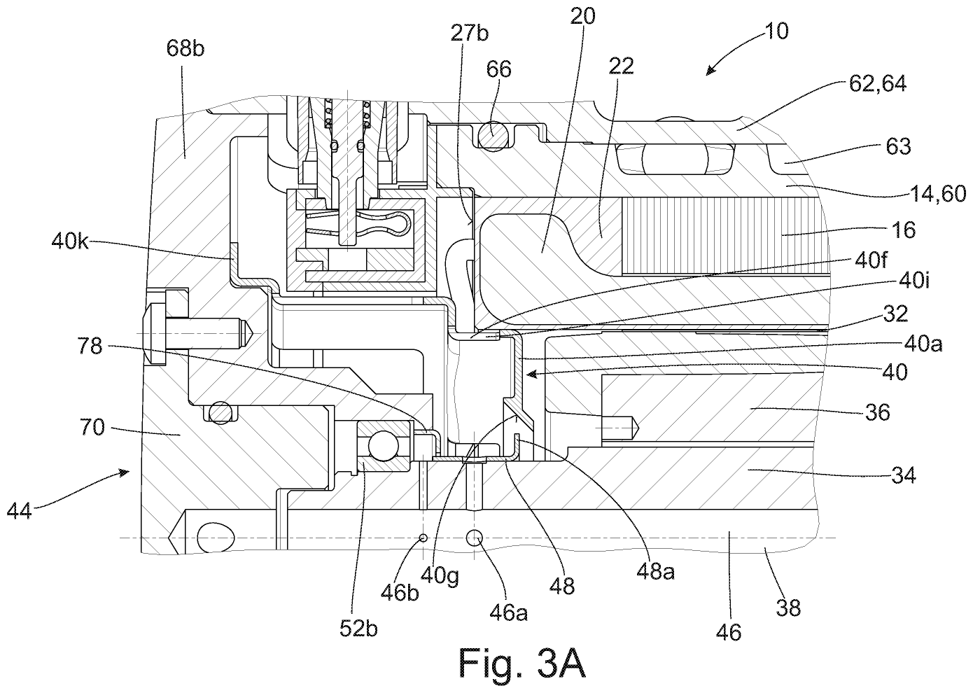

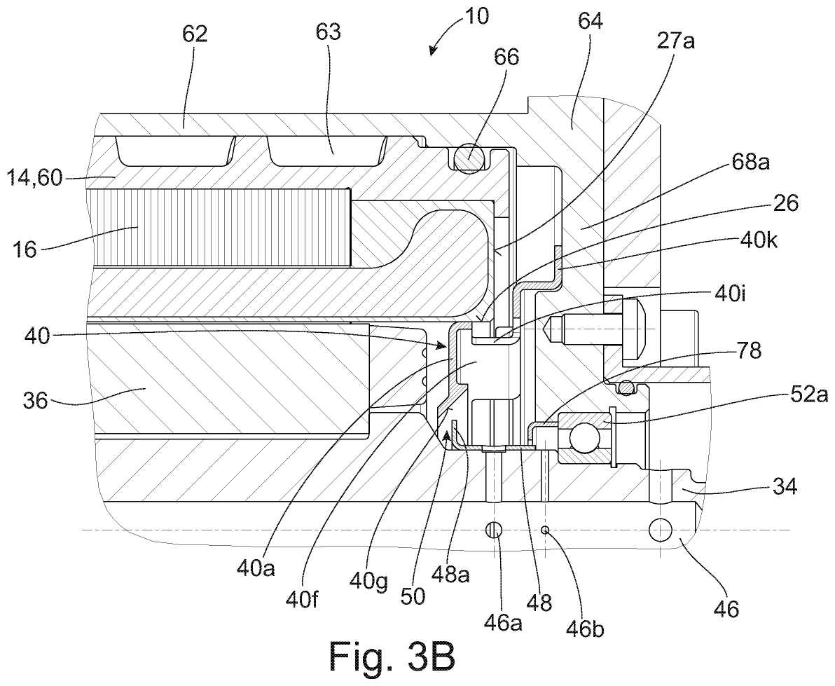

FIGS. 3A, B show an embodiment of an electric machine 10 as an alternative to the electric machine 10 described above. The preceding description of the figures is referred to for the basic construction of this alternative embodiment. In this embodiment, the first fluid conducting element 40 extends on the front side axially beyond a winding head 20 and is axially supported by a supporting surface 40k directly or indirectly at the housing 64, particularly at the bearing endshield 68b (FIG. 3a) or at the housing base 64a (FIG. 3b). Supporting surfaces acting axially at both sides are advantageously provided at a fluid conducting element 40 of this kind so that the fluid conducting element 40 is axially embedded or clamped in when installed in the interior space 30 and is accordingly captively secured to the stator or relative to the stator. A plurality of cutouts 40i extending axially beyond the end of the winding heads 20 in direction of front sides 42, 44 of stator 12 are in turn provided in circumferential direction at the first fluid conducting elements 40, which are pot-shaped or bucket-shaped in this instance, so that a cooling fluid exiting radially from the rotor shaft 34 can pass through to the winding heads 20. Accordingly, the cooling fluid can reach the inner circumferential surfaces 26 and the end faces 27a, b of the winding heads 20 and cool them. The second fluid conducting elements 48 are identical to those shown in FIGS. 1, 2A, B seen from the first fluid outlet openings 46a in direction of the rotor.

On the other hand, for supplying coolant or lubricant to the rotor bearings 52a, b, a stationary conducting element 78 which is shaped as an annular cap is provided at the bearing endshields 68a, b and axially overlaps the second fluid outlet openings 46b at a radial distance therefrom.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-13. (canceled)

14. A electric machine comprising:
a stator including a stator support and a stator lamination stack supporting a stator winding having winding head protruding axially over the stator lamination stack, wherein the winding head is potted with a thermally conductive potting compound forming an outer circumferential surface and an inner circumferential surface, wherein the outer circumferential surface is in thermally conducting contact with the stator support, and wherein the stator has a cylindrical interior space;
a rotor rotatably mounted in the interior space by a rotor shaft so as to form a radial air gap;
the electric machine further comprising a first fluid cooling device for wetting the inner circumferential surface of the winding head with a cooling fluid, at least one first fluid conducting element secured to the winding head and constructed such that a fluid introduced into the interior space is substantially prevented from penetrating into the air gap between rotor and stator during operation of the electric machine.

15. The electric machine according to claim 14, wherein the first fluid conducting element comprises a dividing wall area having a radially outer fastening portion secured in a substantially fluid-tight manner to the inner circumferential surface of the winding head, the first fluid conducting element constructed so as to be closed with the exception of a central through-opening for a rotor shaft.

16. The electric machine according to claim 15, wherein the first fluid conducting element further comprises an axial stop cooperating with the winding head.

17. The electric machine according to claim 16, wherein the first fluid conducting element further comprises in the area of the through-opening a fluid repelling surface opening toward a front side of the electric machine for repelling a fluid impinging on the repelling surface in direction of the front side of the electric machine.

18. The electric machine according claim 14, wherein the first fluid conducting element is produced from a non-ferromagnetic material.

19. The electric machine according claim 14, wherein the first fluid conducting element comprises a fluid inlet channel formed in the rotor shaft and fluidically connected with an area of the interior space facing a front side of the stator by at least one first fluid outlet opening.

20. The electric machine according to claim 19, wherein the rotor shaft comprises in the area of the first fluid outlet opening a second fluid conducting element which, together with the first fluid conducting element, forms a labyrinth seal for the cooling fluid.

21. The electric machine according to claim 20, wherein the rotor shaft comprises in the area of the second fluid conducting element at least one second fluid outlet opening arranged axially adjacent to a rotor bearing; and wherein the second fluid conducting element extends in direction of the rotor bearing, and axially overlaps the second fluid outlet opening at a radial distance therefrom.

22. The electric machine according claim 14, wherein the first fluid cooling device comprises a fluid outlet channel formed at the bottom geodesically with respect to the stator in a normal operating position of the electric machine, the fluid outlet channel fluidically connected to the interior space by at least one fluid inlet opening.

23. The electric machine according claim 14, wherein the electric machine further comprises a second fluid cooling device having a fluid cooling jacket formed at the stator.

24. The electric machine according to claim 23, wherein the fluid cooling jacket comprises a first wall element and a second wall element formed so as to be substantially cylindrical, spaced apart from one another radially and sealed relative to one another.

25. The electric machine according to claim 24, wherein the first wall element comprises the stator support, and the second wall element is formed as a housing of the electric machine.

26. The electric machine according claim 23, wherein the fluid cooling jacket extends axially entirely or at least partially along the winding heads.
